(19) United States
(12) Patent Application Publication
(10) Pub. No.: US 2024/0279446 A1
(43) Pub. Date: Aug. 22, 2024

(54) Polymeric Films Having Reduced Melt Fracture and Related Methods

(71) Applicant: Dover Chemical Corporation, Dover, OH (US)

(72) Inventors: Michael Jakupca, Canton, OH (US); Shawn Cook, Canton, OH (US); John Regula, Baltic, OH (US); Quinn Braun, Akron, OH (US)

(73) Assignee: Dover Chemical Corporation, Dover, OH (US)

(21) Appl. No.: 18/413,459

(22) Filed: Jan. 16, 2024

Related U.S. Application Data
(60) Provisional application No. 63/439,041, filed on Jan. 13, 2023.

(51) Int. Cl. C08L 23/06; C08J 5/18; C08K 5/524

(52) U.S. Cl. CPC C08L 23/06; C08J 5/18; C08K 5/524; C08J 2323/06; C08J 2467/04; C08J 2471/02; C08L 2203/16; C08L 2205/06; C08L 2207/066

(57) ABSTRACT

An extruded film manufactured by a process comprising the steps: compounding a composition having: a polyolefin, a first component that is a polyethylene glycol, a polyethylene glycol mono-ester, or a polyethylene glycol di-ester, and a second component that is a phosphorus-containing compound having one of the following two structures:

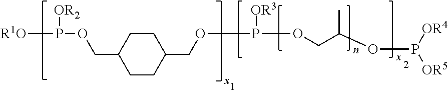

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

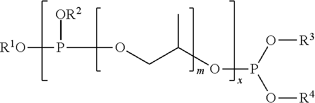

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and manufacturing an extruded film using the compounded composition, wherein the film has reduced melt fracture relative to a film manufactured by the same process and with a composition that is otherwise the same but does not include the first component or the second component.

### CROSS REFERENCE TO RELATED APPLICATIONS

This patent application claims priority to U.S. provisional patent application Ser. No. 63/439,041 having a filing date of Jan. 13, 2023. The subject matter of U.S. provisional patent application Ser. No. 63/439,041 having a filing date of Jan. 13, 2023 is incorporated by reference into this application.

### BACKGROUND OF THE INVENTION

There remains a need to replace fluorinated polymeric processing aids with non-fluorinated polymeric processing aids, and there also remains a need for extruded films having reduced melt fracture.

### BRIEF SUMMARY OF THE INVENTION

An extruded film manufactured by a process comprising the steps: compounding a composition having: a polyolefin, a first component that is a polyethylene glycol, a polyethylene glycol mono-ester, or a polyethylene glycol di-ester, and a second component that is a phosphorus-containing compound having one of the following two structures:

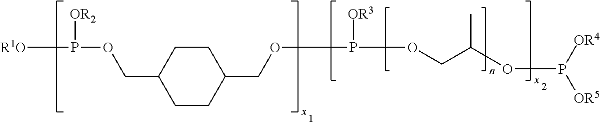

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

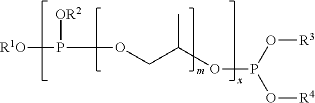

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and manufacturing an extruded film using the compounded composition, wherein the film has reduced melt fracture relative to a film manufactured by the same process and with a composition that is otherwise the same but does not include the first component or the second component.

An extruded film manufactured by a process comprising the steps: compounding a composition having: a polyolefin, a first component that is a polycaprolactone, and a second component that is a phosphorus-containing compound having one of the following two structures:

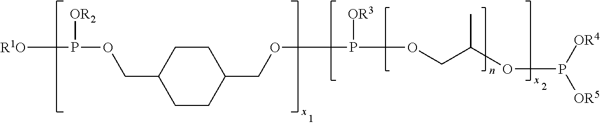

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

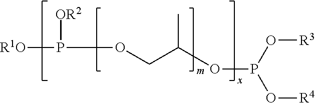

wherein each R¹, R^{2,} R³ and R⁴ is independently selected and is a C₁₀-C₁₈ alkyl moiety; m is an integer ranging from 3-11; and x is an integer ranging from 1-122, wherein the composition does not include a fluorine-containing compound; and manufacturing an extruded film using the compounded composition, wherein the film has reduced melt fracture relative to a film manufactured by the same process and with a composition that is otherwise the same but does not include the first component or the second component.

An extruded film manufactured by a process comprising the steps: compounding a composition having: a polyolefin, a first component that is a polypropylene glycol, a polypropylene glycol mono-ester, or a polypropylene glycol di-ester, and a second component that is a phosphorus-containing compound having one of the following two structures:

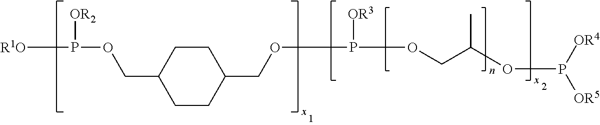

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

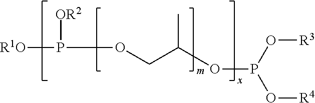

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and manufacturing an extruded film using the compounded composition, wherein the film has reduced melt fracture relative to a film manufactured by the same process and with a composition that is otherwise the same but does not include the first component or the second component.

An extruded film manufactured by a process comprising the steps: compounding a composition having: a polyolefin, a first component that is a polyethylene glycol-polypropylene glycol copolymer, a polyethylene glycol-polycaprolactone copolymer, a polypropylene glycol-polycaprolactone copolymer, or a 1,4 butanediol glycol-polycaprolactone copolymer, and a second component that is a phosphorus-containing compound having one of the following two structures:

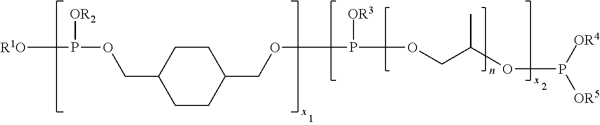

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

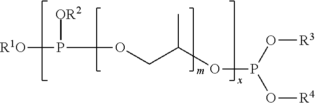

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and manufacturing an extruded film using the compounded composition, wherein the film has reduced melt fracture relative to a film manufactured by the same process and with a composition that is otherwise the same but does not include the first component or the second component.

An extruded film manufactured by a process comprising the steps: compounding a composition having: a polyolefin, a first component that is an ester prepared from a copolymer of polyethylene glycol and polypropylene glycol, and a second component that is a phosphorus-containing compound having one of the following two structures:

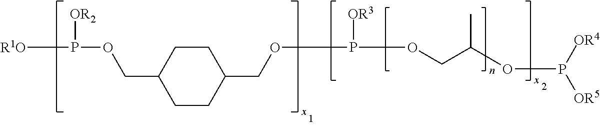

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

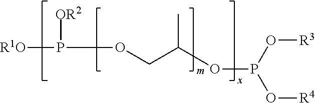

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and manufacturing an extruded film using the compounded composition, wherein the film has reduced melt fracture relative to a film manufactured by the same process and with a composition that is otherwise the same but does not include the first component or the second component.

### DETAILED DESCRIPTION OF THE INVENTION

Embodiments are generally directed to extruded films manufactured from compositions having non-fluorinated polymeric processing aids that cause the films to have reduced melt fracture relative to other films manufactured by the same process and with compositions that are otherwise the same but do not include the non-fluorinated polymeric processing aids.

Very generally, embodiments are directed to an extruded polymeric film manufactured from a compounded composition having a polyolefin, a first component, and a second component.

Regarding chemical nomenclature used herein, copolymers, in many instances are referred to using a hyphen, i.e., a “-” character, to identify the distinction between a first copolymeric unit and a second copolymeric unit. For example, an A-B copolymer indicates that “A” refers to the first copolymeric unit and “B” is the second copolymeric unit. Furthermore, within the chemical structures herein that depict copolymers, “Aₙ-Bₘ”indicates that the first copolymeric unit “A” is present “n” times and the second copolymeric unit “B” is present “m” times. Still further regarding the structures that depict copolymers, copolymeric units that are within a parenthetical (versus brackets) should be understood to teach both the block copolymer embodiment(s) and the random copolymer embodiment(s). For example, in the following illustrative copolymeric structure:

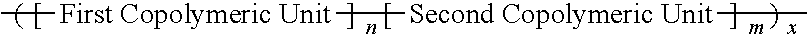

wherein
n is an integer ranging from 1-10;
m is an integer ranging from 1-10; and
x is an integer ranging from 1-1000,
   it should be understood that when x is >1, the parenthetical units that x is referring to may be the same or different. When they are the same, a block copolymer results, and when different, a random copolymer results.

Extruded polymeric films include both blown films and cast films, and methods for manufacturing blown films and cast films are well known in the art. Useful temperatures for manufacturing blown films can be determined by persons having ordinary skill in the art without having to exercise undue experimentation. In embodiments, useful blown-film manufacturing temperatures range from 190° C. to 250° C.; in other embodiments, temperatures of around 220° C. are useful for manufacturing blown films. Useful temperatures for manufacturing cast films can also be determined by persons having ordinary skill in the art without having to exercise undue experimentation. In embodiments, useful cast-film manufacturing temperatures typically range from 250° C. to 330° C. In other embodiments, useful cast-film manufacturing temperatures typically range from 240° C. to 330° C.

All polyolefins known to be useful for manufacturing cast and blown films can be employed in the embodiments. In particular embodiments, useful polyolefins include: polyethylene (PE), linear low-density polyethylene (LLDPE), low-density polyethylene (LDPE), high-density polyethylene (HDPE), polypropylene (PP), and combinations thereof.

In embodiments, the first component is a polyethylene glycol, a polyethylene glycol mono-ester, or a polyethylene glycol di-ester. In embodiments, the polyethylene glycol has the structure:

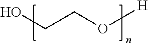

wherein
n is an integer ranging from 3-500.

In embodiments, polyethylene glycol in the range of 1000 g/mol (n being approximately 23) to 10,000 g/mol (n being approximately 227) are useful.

In embodiments, the polyethylene glycol mono-ester has the structure:

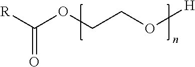

wherein
n is an integer ranging from 3-500, and
R is a C₁-C₂₈ saturated or unsaturated moiety.

Useful embodiments also include polyethylene glycol mono-esters having the structure:

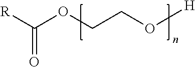

wherein
n is an integer ranging from 3-500, and
R is a C₆-C₂₀ saturated or unsaturated moiety.

In embodiments, the polyethylene glycol di-ester has the structure:

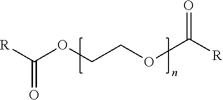

wherein
n is an integer ranging from 3-500, and
each R is independently selected and is a C₁-C₂₈ saturated or unsaturated moiety.

In other embodiments, the first component is a polycaprolactone. In embodiments, the polycaprolactone has the structure:

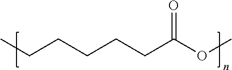

wherein
n is an integer ranging from 3-500.

In other embodiments, the first component is a polypropylene glycol, a polypropylene glycol mono-ester, or a polypropylene glycol di-ester. In embodiments, the polypropylene glycol has the structure:

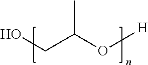

wherein
n is an integer ranging from 3-500;

the polypropylene glycol mono-ester has the structure:

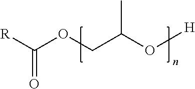

wherein
n is an integer ranging from 3-500, and
R is a C₁-C₂₈ saturated or unsaturated moiety; and

the polypropylene glycol di-ester has the structure:

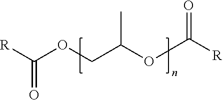

wherein
n is an integer ranging from 3-500, and
each R is independently selected and is a C₁-C₂₈ saturated or unsaturated moiety.

In other embodiments, the first component is a polyethylene glycol-polypropylene glycol copolymer. In embodiments, the polyethylene glycol-polypropylene glycol copolymer has the structure:

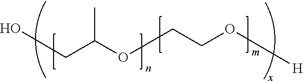

wherein
n is an integer ranging from 1-500,
m is an integer ranging from 1-500, and
x is an integer ranging from 1-500.

In still other embodiments, the first component is an ester prepared from a copolymer of polyethylene glycol and polypropylene glycol. In embodiments, the ester prepared from a copolymer of polyethylene glycol and polypropylene glycol has one of the following two structures:

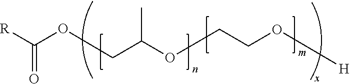

wherein
n is an integer ranging from 1-500,
m is an integer ranging from 1-500,
x is an integer ranging from 1-500, and
R is a C₁-C₂₈ saturated or unsaturated moiety
   or

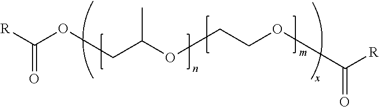

wherein
n is an integer ranging from 1-500,
m is an integer ranging from 1-500,
x is an integer ranging from 1-500, and
each R is independently selected from a C₁-C₂₈ saturated or unsaturated moiety.

In still other embodiments, the first component is: (i) a polyethylene glycol-polycaprolactone copolymer, or (ii) a polypropylene glycol-polycaprolactone copolymer. In those embodiments in which the first component is a polyethylene glycol-polycaprolactone copolymer, the polyethylene glycol-polycaprolactone copolymer has one of the following three structures:

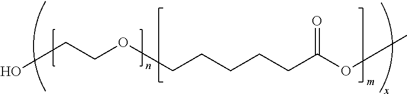

wherein
n is an integer ranging from 1-500,
m is an integer ranging from 1-500, and
x is an integer ranging from 1-500;
   or

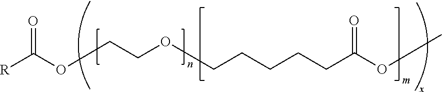

wherein
n is an integer ranging from 1-500,
m is an integer ranging from 1-500,
x is an integer ranging from 1-500, and
R is a C₁-C₂₈ saturated or unsaturated moiety;
   or

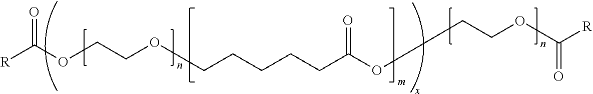

wherein
n is an integer ranging from 1-500,
m is an integer ranging from 1-500,
x is an integer ranging from 1-500, and
each R is independently selected from a C₁-C₂₈ saturated or unsaturated moiety.

And in those embodiments in which the first component is a polypropylene glycol-polycaprolactone copolymer, the polypropylene glycol-polycaprolactone copolymer has one of the following three structures:

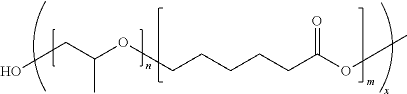

wherein
n is an integer ranging from 1-500,
m is an integer ranging from 1-500, and
x is an integer ranging from 1-500
   or

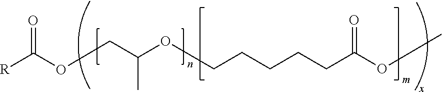

wherein
n is an integer ranging from 1-500,
m is an integer ranging from 1-500,
x is an integer ranging from 1-500, and
R is a C₁-C₂₈ saturated or unsaturated moiety;
   or

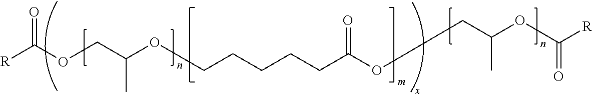

wherein
n is an integer ranging from 1-500,
m is an integer ranging from 1-500,
x is an integer ranging from 1-500, and
each R is independently selected from a C₁-C₂₈ saturated or unsaturated moiety.

In still other embodiments, the first component is a 1,4 butanediol glycol-polycaprolactone copolymer that has one of the following three structures:

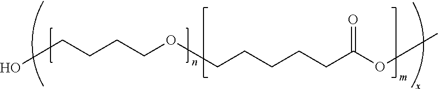

wherein
n is an integer ranging from 1-500,
m is an integer ranging from 1-500,
x is an integer ranging from 1-500
   or

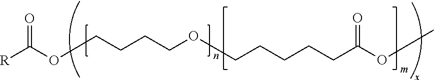

wherein
n is an integer ranging from 1-500,
m is an integer ranging from 1-500,
x is an integer ranging from 1-500, and
R is a C₁-C₂₈ saturated or unsaturated moiety;
   or

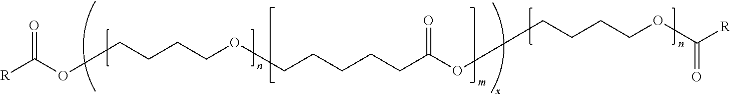

wherein
n is an integer ranging from 1-500,
m is an integer ranging from 1-500,
x is an integer ranging from 1-500, and
R is a C₁-C₂₈ saturated or unsaturated moiety.

In embodiments the polycaprolactone copolymers can be a diol having both ends of the polymer chain terminated with a hydroxyl moiety.

In embodiments, the first component is in the composition in an amount ranging from 250-5000 parts per million.

In embodiments, the second component is a phosphorus-containing compound having one of the following two structures:

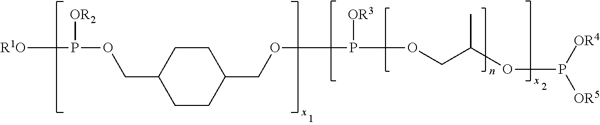

wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
   or

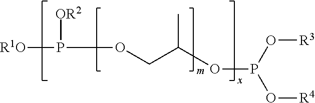

wherein
each R¹, R², R³ and R⁴ is independently selected and is a C₁₀-C₁₈ alkyl moiety;
m is an integer ranging from 3-11; and
x is an integer ranging from 1-122.

The second component can be obtained commercially, or it can be manufactured using a known method.

In embodiments, the second component is in the composition in an amount ranging from 250-5000 parts per million.

Methods for compounding the polymeric compositions described in the embodiments are well known, and any of them may be used. Persons having ordinary skill in the art will be able to determine compounding conditions without having to exercise undue experimentation. Non-limiting examples of known compounding methods include: banbury mixing, single-screw compounding, and twin-screw compounding.

All of the embodiments described herein specifically exclude the use of fluorine-containing compounds.

All of the embodiments described herein have reduced melt fracture relative to a film manufactured by the same process and with a composition that is otherwise the same but does not include the first component or the second component.

Any additive or additives known useful for polymer compounding or processing can be used in the disclosed embodiments.

### Experimental

The processing aid packages containing the polymeric phosphites in combination with a lubricant were evaluated under a number of different processing temperatures and conditions and resin grades to show their effectiveness.

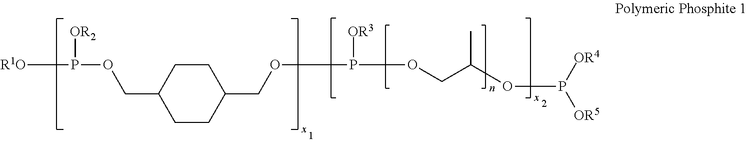

wherein
each R¹, R², R³, R⁴ and R⁵ is independently selected and is a C₁₀-C₁₈ alkyl moiety;
n is an integer ranging from 3-11; and
the sum of x₁, x₂ is an integer ranging from 1-251.

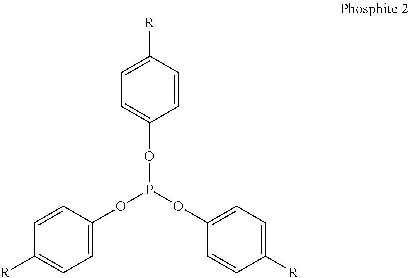

wherein R is a branched or linear nonyl group

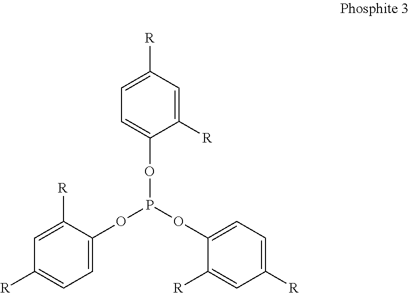

wherein R is an amyl group or a hydrogen.

Product is a mixture of 4 phosphites produced from a mixture of amylphenol and di-amylphenol.

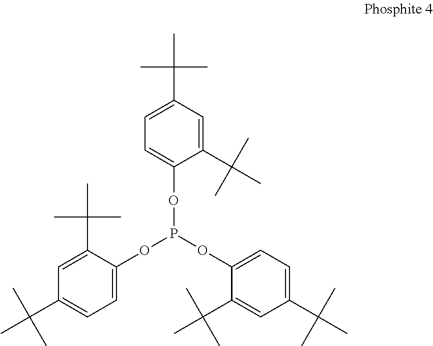 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

### Example 1

The processing aid package of the current invention was evaluated to show the synergistic performance of the polymeric phosphite 1 in combination with one of the lubricant additives. The formulations were compounded into a 0.85 MI LLDPE Zieglar Natta catalyzed resin using a ¾ inch single screw Brabender extruder. The polymer was extruded through a 2 inch by 0.02 inch film die at 80 rpm and 200 C to produce a 0.02 inch thick film. The extruder conditions were picked so that a formulation containing no process aid additives would have melt fracture on the surface. Each formulation was extruded through the die for 30 min. After 30 min, samples of the film were observed to determine if any melt fracture remained on the surface. The extruder was purged between each formulation to remove any residues from the previous formulation that may affect the result.

Several different commercially available phosphites were compared to polymeric phosphite 1 to determine if they would clear melt fracture in combination with polyethylene glycol 3350 (PEG 3350). Each phosphite was loaded at 1600 ppm and PEG 3350 was loaded at 800 ppm. Only the combination of polymeric phosphite 1 and PEG 3350 cleared the melt fracture after 30 min of extrusion. None of the phosphites or the PEG 3350 could clear the melt fracture on their own.

| Ingredient | A | B | C | D | E | F | G | I | J |
|---|---|---|---|---|---|---|---|---|---|
| 0.85MI LLDPE | X | X | X | X | X | X | X | X | X |
| Polymeric Phosphite 1 | | 1600 | 1600 | | | | | | |
| Phosphite 3 | | | | 1600 | 1600 | | | | |
| Phosphite 4 | | | | | | 1600 | 1600 | | |
| Phosphite 2 | | | | | | | | 1600 | 1600 |
| PEG 3350 | 800 | | 800 | | 800 | | 800 | | 800 |
| Time (min) to clear | N/A | N/A | 30 | N/A | N/A | N/A | N/A | N/A | N/A |
| melt fracture | | | | | | | | | |

### Example 2

3 different polyethylene glycol samples with different average molecular weights were evaluated in combination with polymeric phosphite 1 to show that a wide range of polyethylene glycols are effective at clearing melt fracture. These were extruded under the same conditions as example 1 and the same grade of resin was used.

All three formulations cleared melt fracture indicating a broad range of polyethylene glycols work synergistically with the polymeric phosphites.

| Ingredient | | | |
|---|---|---|---|
| 0.85 MI LLDPE | X | X | X |
| Polymeric Phosphite 1 | 1600 | 1600 | 1600 |
| PEG 2000 | 800 | | |
| PEG 3350 | | 800 | |
| PEG 8000 | | | 800 |
| Time to Clear (min.) | 25 | 30 | 20 |

### Example 3

The combination of the polymeric phosphite 1 and PEG 3350 was evaluated using a lab scale blown film line to show their effectiveness at clearing melt fracture using a different film production technique. The formulations were compounded using a 26 mm co-rotating twin screw extruder. Blown film was produced by extruding a 1 MI LLDPE using a ¾″ single screw extruder at 180 C and 60 RPM connected to a 2 inch blown film die. Blown film was produced for 30 min and the amount of time it took for the film to clear was recorded. The combination of polymeric phosphite 1 and PEG 3350 cleared the melt fracture in 15 min while the polymeric phosphite by itself did not clear the melt fracture after 30 min.

| Ingredient | | | |
|---|---|---|---|
| Polymeric Phosphite 1 | 1600 | 2000 | 1600 |
| PEG-3350 | | | 800 |
| 1.5 MI LLDPE Resin | X | X | X |
| Time to Clear (min.) | N/A | N/A | 15 |

### Example 4

A polycaprolactone co-polymer with 1,4 butanediol having an average molecular weight of 4000 g/mol was evaluated in combination with polymeric phosphite 1 in 3 different grades of linear low density polyethylene. The formulations were compounded using a 26mm co-rotating twin screw extruder. Blown film was the produced by extruding the resins using a ¾″ single screw extruder at 180 C and 60 RPM connected to a 2 inch blown film die. The films were extruded for 30 min and observed visually to determine when the melt fracture cleared.

The polycaprolactone co-polymer did not clear the melt fracture after 30 min in any of the grades when used by itself. The combination of polymeric phosphite 1 and the polycaprolactone co-polymer cleared melt fracture in all three resin grades.

Ingredient

| 1MI LLDPE | X | X | | | | |
|---|---|---|---|---|---|---|
| 0.85 MI LLDPE | | | X | X | | |
| 1MI LLDPE | | | | | X | X |
| Polymeric Phosphite 1 | | 2000 | | 2000 | | 1500 |
| Polycaprolactone co-polymer | 1200 | 1200 | 1200 | 1200 | 1200 | 1200 |
| Time to Clear (min.) | N/A | 15 | N/A | 24 | N/A | 20 |

### Example 5

A polycaprolactone co-polymer with 1,4 butanediol having an average molecular weight of 4000 g/mol was evaluated with a variety of phosphites to see if the combination of any of these would clear melt fracture. The formulations were compounded into a 0.85 MI LLDPE Zieglar Natta catalyzed resin using a ¾ inch single screw Brabender extruder. The polymer was extruded through a 2 inch by 0.02 inch film die at 80 rpm and 200 C to produce a 0.02 inch thick film. The formulations were extruded for 30 min and the % of the polymer that was clear of melt fracture was estimated visually. The combination of polymeric phosphite and polycaprolactone nearly cleared the film completely and the polycaprolactone control cleared about 50% of the film. All of the other phosphite formulations showed similar or worse performance than the polycaprolactone by itself.

Ingredient

| 0.85MI LLDPE | X | X | X | X | X | X |
|---|---|---|---|---|---|---|
| Polycaprolactone co-polymer | 800 | 800 | | 800 | | 800 |
| Polymeric Phosphite 1 | | 1600 | | | | |
| Phosphite 3 | | | 1600 | 1600 | | |
| Phosphite 4 | | | | | 1600 | 1600 |
| % Clear | 50 | 95 | 0 | 0 | 2 | 40 |

1. An extruded film manufactured by a process comprising the steps:
compounding a composition having:
a polyolefin,
a first component that is a polyethylene glycol, a polyethylene glycol mono-ester, or a polyethylene glycol di-ester, and
a second component that is a phosphorus-containing compound having one of the following two structures: 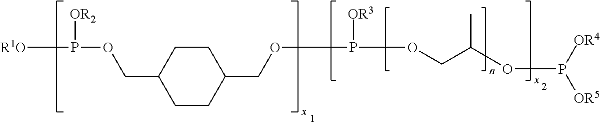
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 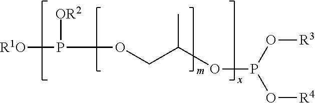
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and
manufacturing an extruded film using the compounded composition, wherein the film has reduced melt fracture relative to a film manufactured by the same process and with a composition that is otherwise the same but does not include the first component or the second component.

2. The extruded film of claim 1, wherein the polyethylene glycol has the structure: 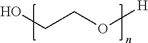
wherein
n is an integer ranging from 3-500;
the polyethylene glycol mono-ester has the structure: 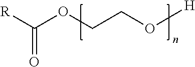
wherein
n is an integer ranging from 3-500, and
R is a C₁-C₂₈ saturated or unsaturated moiety; and
the polyethylene glycol di-ester has the structure: 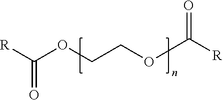
wherein
n is an integer ranging from 3-500, and
each R is independently selected and is a C₁-C₂₈ saturated or unsaturated moiety.

3. The extruded film of claim 1, wherein the first component is in the composition in an amount ranging from 250-5000 parts per million, and
the second component is in the composition in an amount ranging from 250-5000 parts per million.

4. An extruded film manufactured by a process comprising the steps:
compounding a composition having:
a polyolefin,
a first component that is a polycaprolactone, and
a second component that is a phosphorus-containing compound having one of the following two structures: 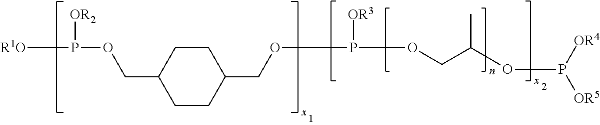
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 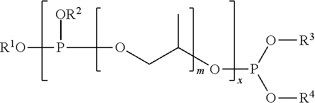
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and manufacturing an extruded film using the compounded composition,
wherein the film has reduced melt fracture relative to a film manufactured by the same process and with a composition that is otherwise the same but does not include the first component or the second component.

5. The extruded film of claim 4, wherein the polycaprolactone has the structure: 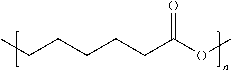
wherein
n is an integer ranging from 3-500.

6. The extruded film of claim 4, wherein the first component is in the composition in an amount ranging from 250-5000 parts per million, and
the second component is in the composition in an amount ranging from 250-5000 parts per million.

7. An extruded film manufactured by a process comprising the steps:
compounding a composition having:
a polyolefin,
a first component that is a polypropylene glycol, a polypropylene glycol mono-ester, or a polypropylene glycol di-ester, and
a second component that is a phosphorus-containing compound having one of the following two structures: 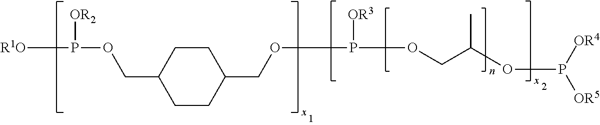
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 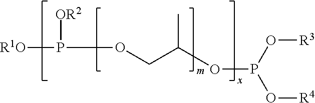
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and manufacturing an extruded film using the compounded composition,
wherein the film has reduced melt fracture relative to a film manufactured by the same process and with a composition that is otherwise the same but does not include the first component or the second component.

8. The extruded film of claim 7, wherein the polypropylene glycol has the structure: 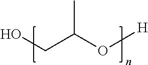
wherein
n is an integer ranging from 3-500;
the polypropylene glycol mono-ester has the structure: 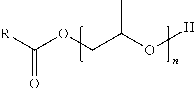
wherein
n is an integer ranging from 3-500, and
R is a C₁-C₂₈ saturated or unsaturated moiety; and
the polypropylene glycol di-ester has the structure: 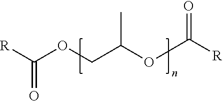
wherein
n is an integer ranging from 3-500, and
each R is independently selected and is a C₁-C₂₈ saturated or unsaturated moiety.

9. The extruded film of claim 7, wherein the first component is in the composition in an amount ranging from 250-5000 parts per million, and
the second component is in the composition in an amount ranging from 250-5000 parts per million.

10. An extruded film manufactured by a process comprising the steps:
compounding a composition having:
a polyolefin,
a first component that is a polyethylene glycol-polypropylene glycol copolymer, a polyethylene glycol-polycaprolactone copolymer, a polypropylene glycol-polycaprolactone copolymer, or a 1,4 butanediol glycol-polycaprolactone copolymer, and
a second component that is a phosphorus-containing compound having one of the following two structures: 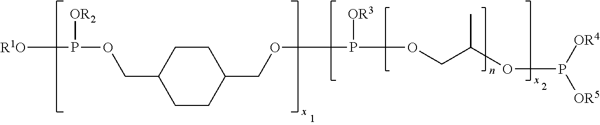
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 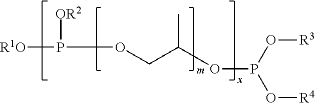
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and manufacturing an extruded film using the compounded composition,
wherein the film has reduced melt fracture relative to a film manufactured by the same process and with a composition that is otherwise the same but does not include the first component or the second component.

11. The extruded film of claim 10, wherein the polyethylene glycol-polypropylene glycol copolymer has the structure: 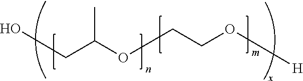
wherein
n is an integer ranging from 1-500,
m is an integer ranging from 1-500, and
x is an integer ranging from 1-500;
the polyethylene glycol-polycaprolactone copolymer has one of the following three structures: 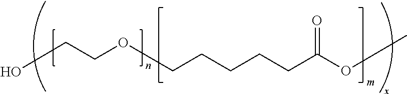
wherein
n is an integer ranging from 1-500,
m is an integer ranging from 1-500, and
x is an integer ranging from 1-500;
or 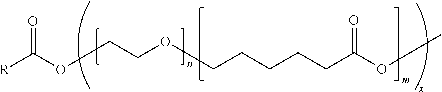
wherein
n is an integer ranging from 1-500,
m is an integer ranging from 1-500,
x is an integer ranging from 1-500, and
R is a C₁-C₂₈ saturated or unsaturated moiety;
or 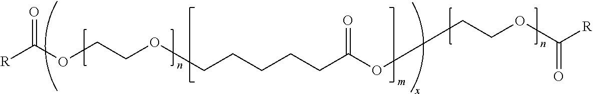
wherein
n is an integer ranging from 1-500,
m is an integer ranging from 1-500,
x is an integer ranging from 1-500, and
each R is independently selected from a C₁-C₂₈ saturated or unsaturated moiety;
the polypropylene glycol-polycaprolactone copolymer has one of the following three structures: 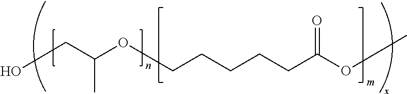
wherein
n is an integer ranging from 1-500,
m is an integer ranging from 1-500, and
x is an integer ranging from 1-500
or 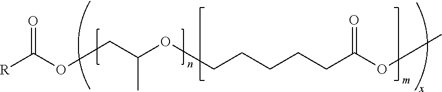
wherein
n is an integer ranging from 1-500,
m is an integer ranging from 1-500,
x is an integer ranging from 1-500, and
R is a C₁-C₂₈ saturated or unsaturated moiety;
or 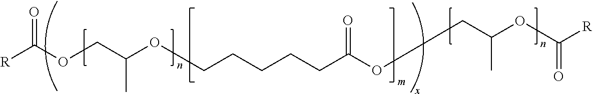
wherein
n is an integer ranging from 1-500,
m is an integer ranging from 1-500,
x is an integer ranging from 1-500, and
each R is independently selected from a C₁-C₂₈ saturated or unsaturated moiety; and
the 1,4 butanediol glycol-polycaprolactone copolymer has one of the following three structures: 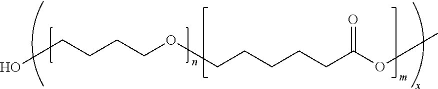
wherein
n is an integer ranging from 1-500,
m is an integer ranging from 1-500,
x is an integer ranging from 1-500
or 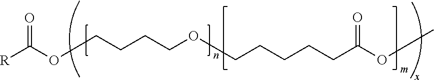
wherein
n is an integer ranging from 1-500,
m is an integer ranging from 1-500,
x is an integer ranging from 1-500, and
R is a C₁-C₂₈ saturated or unsaturated moiety;
or 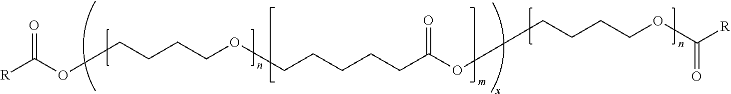
wherein
n is an integer ranging from 1-500,
m is an integer ranging from 1-500,
x is an integer ranging from 1-500, and
R is a C₁-C₂₈ saturated or unsaturated moiety.

12. The extruded film of claim 10, wherein the first component is in the composition in an amount ranging from 250-5000 parts per million, and
the second component is in the composition in an amount ranging from 250-5000 parts per million.

13. An extruded film manufactured by a process comprising the steps:
compounding a composition having:
a polyolefin,
a first component that is an ester prepared from a copolymer of polyethylene glycol and polypropylene glycol, and
a second component that is a phosphorus-containing compound having one of the following two structures: 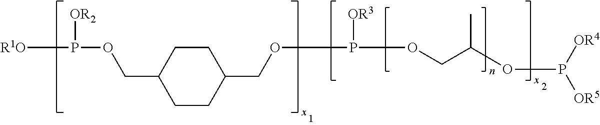
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 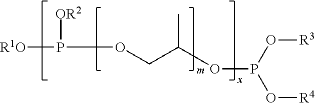
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and manufacturing an extruded film using the compounded composition,
wherein the film has reduced melt fracture relative to a film manufactured by the same process and with a composition that is otherwise the same but does not include the first component or the second component.

14. The extruded film of claim 13, wherein the ester prepared from a copolymer of polyethylene glycol and polypropylene glycol has one of the following two structures: 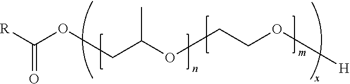
wherein
n is an integer ranging from 1-500,
m is an integer ranging from 1-500,
x is an integer ranging from 0-500, and
R is a C₁-C₂₈ saturated or unsaturated moiety
or 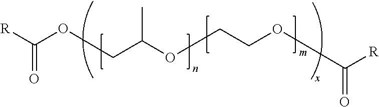
wherein
n is an integer ranging from 1-500,
m is an integer ranging from 1-500,
x is an integer ranging from 0-500, and
each R is independently selected from a C₁-C₂₈ saturated or unsaturated moiety.

15. The extruded film of claim 13, wherein the first component is in the composition in an amount ranging from 250-5000 parts per million, and
the second component is in the composition in an amount ranging from 250-5000 parts per million.
